(19) United States
(12) Patent Application Publication
(10) Pub. No.: US 2003/0126055 A1
(43) Pub. Date: Jul. 3, 2003

(54) Method for describing financial instruments

(76) Inventors: Christophe Thal, London (GB); Param Parmar, Slough (GB)

Correspondence Address: CLIFFORD CHANCE US LLP, 200 PARK AVENUE, NEW YORK, NY, 10166, US

(21) Appl. No.: 10/090,255

(22) Filed: Mar. 4, 2002

Related U.S. Application Data
(60) Provisional application No. 60/343,696, filed on Dec. 27, 2001.

(51) Int. Cl. G06F 17/60

(52) U.S. Cl. 705/36

(57) ABSTRACT

A method is provided for communicating a description of a bond between a first entity and a second entity and includes the step of selecting at least some attributes that are associated with the bond from a plurality of bond attributes. Next, a value for each of the at least some attributes is chosen. Next, the description of the bond is created by formatting the values for the at least some attributes according to a document type definition. Finally, the description of the bond is communicated between the first entity and the second entity.

### CROSS-REFERENCE TO RELATED APPLICATION

This application claims the benefit of the filing date of U.S. provisional application serial No. 60/343,696 entitled “Method for Describing Financial Instruments” which was filed on Dec. 27, 2001.

### BACKGROUND

The following invention relates to a method for describing financial instruments and, in particular, to a method for improving the efficiency of communicating information pertaining to debt instruments.

Debt instruments are complex investment products the performance of which typically depends on a several basic characteristics. For example, a bond's price-yield relationship depends on its maturity, redemption features, coupon features (for e.g., step ups) and the convention in the underlying market (for e.g., the yield calculation method). In addition to these basic features, a particular bond may include other features that affect the bonds yield including, by way of example, the type of coupon provided, the settlement date, the ex-dividend date, the type of accrual, the amortization rate, the capitalization date and the recovery right. In all there are approximately 40 features that effect bond yield. For any given bond, however, only a subset of these features may be relevant to describe the yield of the particular bond.

Because the yield of a bond depends on numerous characteristics that can vary depending on the bond type, it is important that those transacting in a particular bond clearly and accurately document the features of the bond to avoid any misunderstandings between the transacting parties. Presently, however, there is no uniform method for accurately describing the numerous features of a bond. The need for an accurate and uniform method for describing bond information is particularly great in situations where the bond information is to be electronically communicated between two systems (for example, a client device requesting a price quote from a pricing engine). In this context, not having a method for accurately and uniformly describing bond characteristics may result in different systems being unable to accurately and effectively communicate bond information.

Accordingly, it is desirable to provide a method for describing debt instruments and for improving the efficiency of communicating information pertaining to debt instruments.

### SUMMARY OF THE INVENTION

The present invention is directed to overcoming the drawbacks of the prior art. Under the present invention a method is provided for communicating a description of a bond between a first entity and a second entity and includes the step of selecting at least some attributes that are associated with the bond from a plurality of bond attributes. Next, a value for each of the at least some attributes is chosen. Next, the description of the bond is created by formatting the values for the at least some attributes according to a document type definition. Finally, the description of the bond is communicated between the first entity and the second entity.

In an exemplary embodiment, the bond attributes include maturity and redemption.

In another exemplary embodiment, the bond attributes includes at least one attribute selected from the group including a coupon type, a settlement date, an ex-dividend date, an accrual type, an amortization rate, a capitalization date, a tax status and a recovery right.

In yet another exemplary embodiment, the bond has a yield and at least some of the at least some attributes relate to the yield of the bond.

In still yet another exemplary embodiment, the at least some of the at least some of the attributes identify the bond.

In an exemplary embodiment, the document type definition conforms to an Extensible Markup Language syntax.

In another exemplary embodiment, the bond is a corporate bond.

In yet another exemplary embodiment, the bond is a government bond.

In still yet another exemplary embodiment, the bond is an emerging market bond.

Under the present invention, a method for forming a description of a bond is provided and includes the step of selecting at least some attributes that are associated with the bond from a plurality of bond attributes. Next, a value for each of the at least some attributes is chosen. Finally, the description of the bond is created by formatting the values for the at least some attributes according to a document type definition.

In an exemplary embodiment, a first entity and a second entity is included and the method includes the step of communicating the description of the bond between the first entity and the second entity.

Under the present invention, a system for communicating a description of a bond is provided and includes a first entity that selects at least some attributes that are associated with the bond from a plurality of bond attributes. The first entity also chooses a value for each of the at least some attributes and the first entity then creates the description of the bond by formatting the values for the at least some attributes according to a document type definition. Also included is a second entity that is in communications with the first entity. When the first entity communicates the description of the bond to the second entity, the second entity interprets the description according to the document type definition.

In an exemplary embodiment, the first entity includes an XML processor for formatting the values for the at least some attributes according to a document type definition.

In another exemplary embodiment, the second entity includes an XML processor for interpreting the description according to the document type definition.

Accordingly, a method is provided for describing debt instruments and for improving the efficiency of communicating information pertaining to debt instruments.

The invention accordingly comprises the features of construction, combination of elements and arrangement of parts that will be exemplified in the following detailed disclosure, and the scope of the invention will be indicated in the claims. Other features and advantages of the invention will be apparent from the description, the drawings and the claims.

### DESCRIPTION OF THE DRAWINGS

For a fuller understanding of the invention, reference is made to the following description taken in conjunction with the accompanying drawings, in which:

FIG. 1 is an Extensible Markup Language document type definition for describing a bond in accordance with the present invention;

FIG. 2 is an Extensible Markup Language document for describing a particular corporate bond using the document type definition of FIG. 1; and

FIG. 3 is a block diagram of a system in which bond information is communicated according to the method of the present invention.

### DETAILED DESCRIPTION OF THE PREFERRED EMBODIMENTS

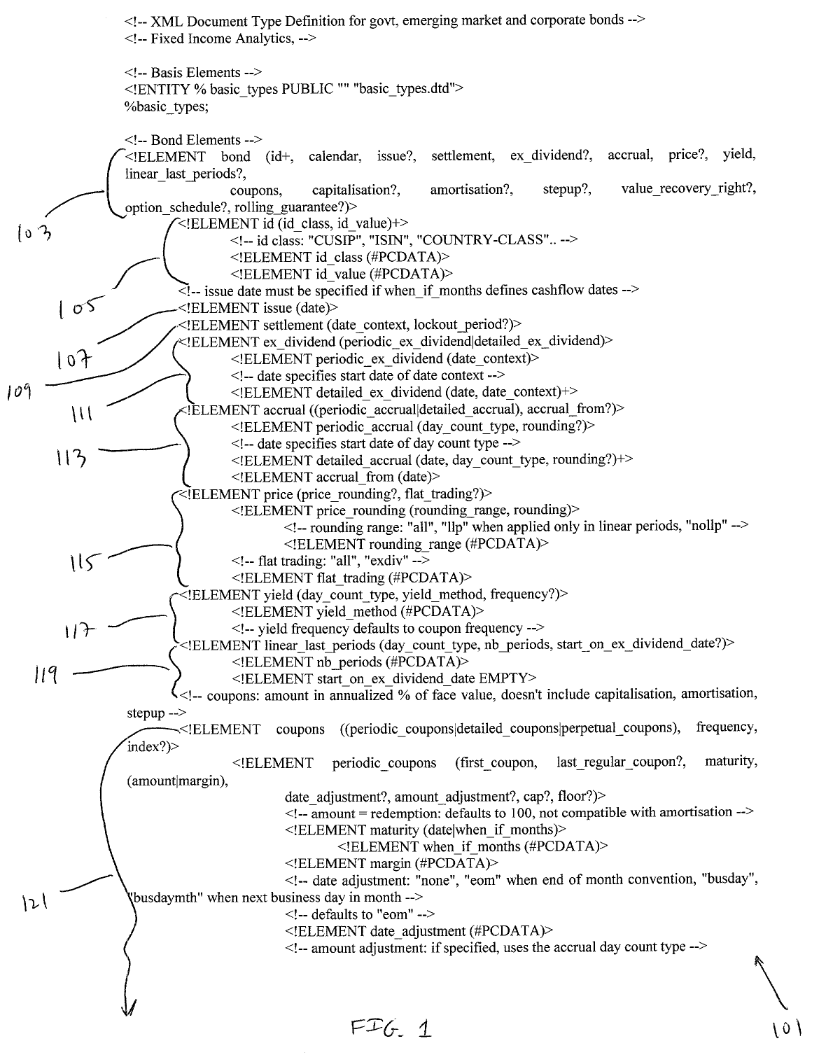

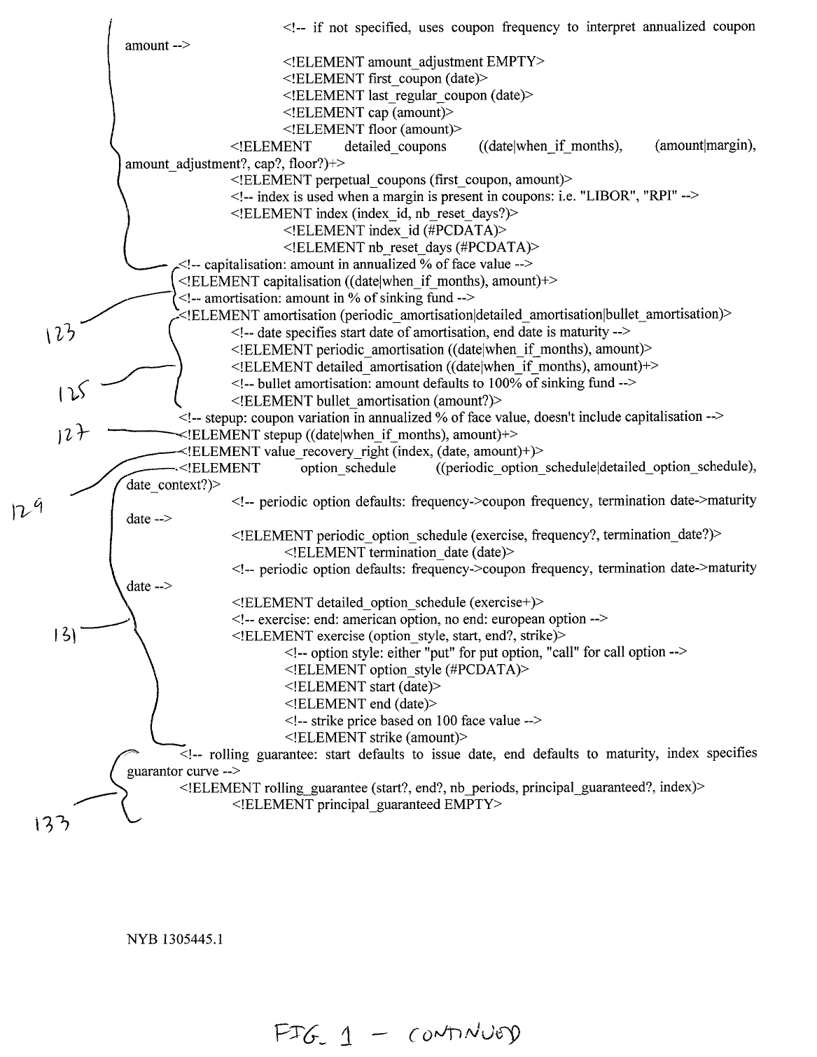

Referring now to FIG. 1, there is shown an Extensible Markup Language (XML) document type definition (DTD) 101 for describing a bond in accordance with an exemplary embodiment of the present invention. XML is an open technology standard designed to facilitate structured data interchange on the World Wide Web. The XML standard includes the use of document type definitions that provide a formal description format for specific documents using XML syntax. More specifically, a DTD typically sets out the names that are to be used for the different types of element, where they may occur within the document and the ways the different elements may combine for a particular document type. XML and the use of document type definitions are discussed in detail at http://www.w3.org/TR/xmlschema-0/, the contents of which are incorporated herein by reference.

As described above, a bond's yield may depend on any number of attributes (see Appendix for a listing and description of these attributes). For example, DTD 101 of FIG. 1 may be used for describing bonds by using various bond attributes including attributes that pertain to bond identification, calendar, issue date, settlement date, ex-dividend date, accrual information, price, yield, payment periods, coupons, capitalization, amortization, stepup date, value recovery right, option schedule and rolling guarantee information associated with a particular bond. The bond features that may be used to describe a particular bond using DTD 101 are listed in section 103 of DTD 101. The bond features set forth in section 103 may be used to describe a variety of different bond types including, by way of non-limiting example, government, emerging market and corporate bonds.

DTD 101 includes a section to be used for describing any of the various bond features listed in section 103 including an issue date section 107, a settlement date section 109, an ex-dividend section 111, an accrual section 113, a price section 115, a yield section 117, a periods section 119, a coupons section 121, a capitalization section 123, an amortization section 125, a stepup section 127, a recovery right section 129, an option schedule section 131 and a rolling guarantee section 133.

In addition to the bond attributes listed in section 103, DTD 101 also may include other bond attributes that are necessary for fully defining the bond attributes. For example, the coupon feature of a bond may require that additional attributes be specified for fully defining the bond's coupon feature. These additional attributes may include, by way of non-limiting example, whether the coupons are periodic coupons, detailed coupons or perpetual coupons.

In addition to the bond features included in section 103, in an exemplary embodiment a DTD may be formed including any other attributes that are required to fully describe any other type of bond. Also, any features not impacting any of the analytic calculations may not included in a DTD used to describe the particular bond.

DTD 101 also includes certain elements that are used to describe a particular bond but that do not relate to the yield performance of the bond. For example, section 105 of DTD 101 is a bond identification element in which bond attributes such as, by way of non-limiting example, CUSIP number, ISIN number and country class are included to identify the particular bond.

Because DTD 101 is a comprehensive template for describing the features and attributes of a particular bond in a uniform way, various elements included in DTD 101 may not be relevant for describing a given bond. Thus, only a portion of the elements included in DTD 101 may be required to fully describe the attributes of a given bond.

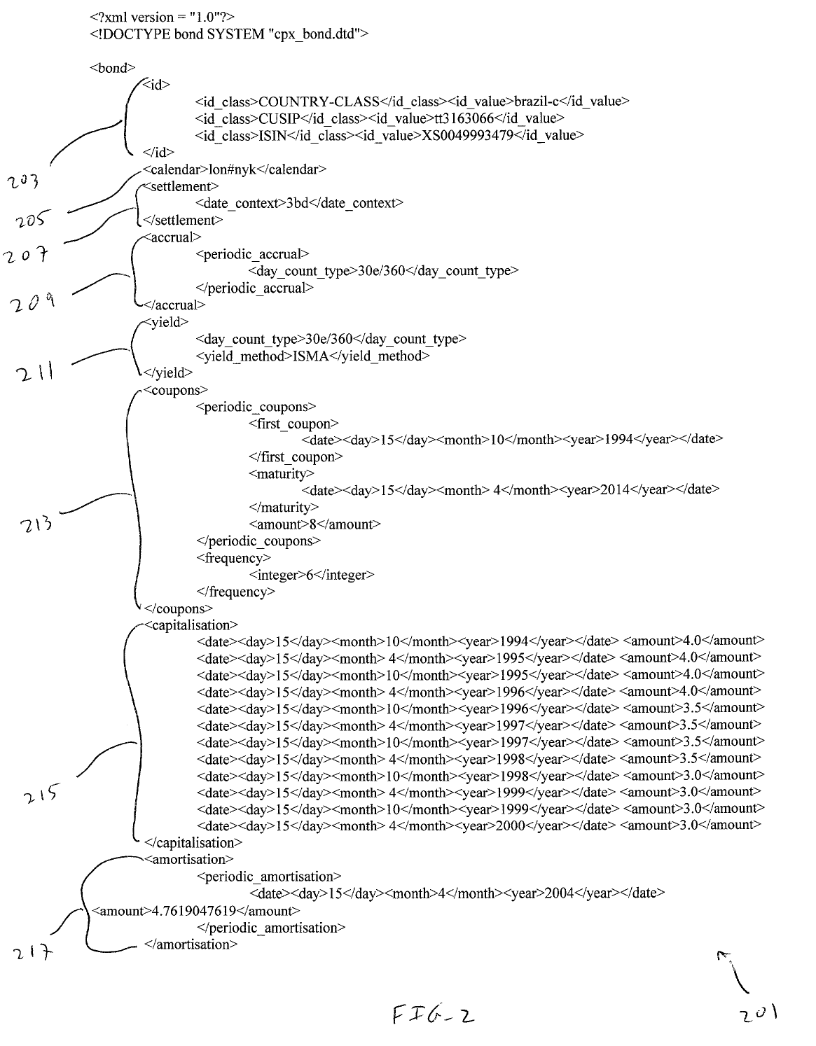

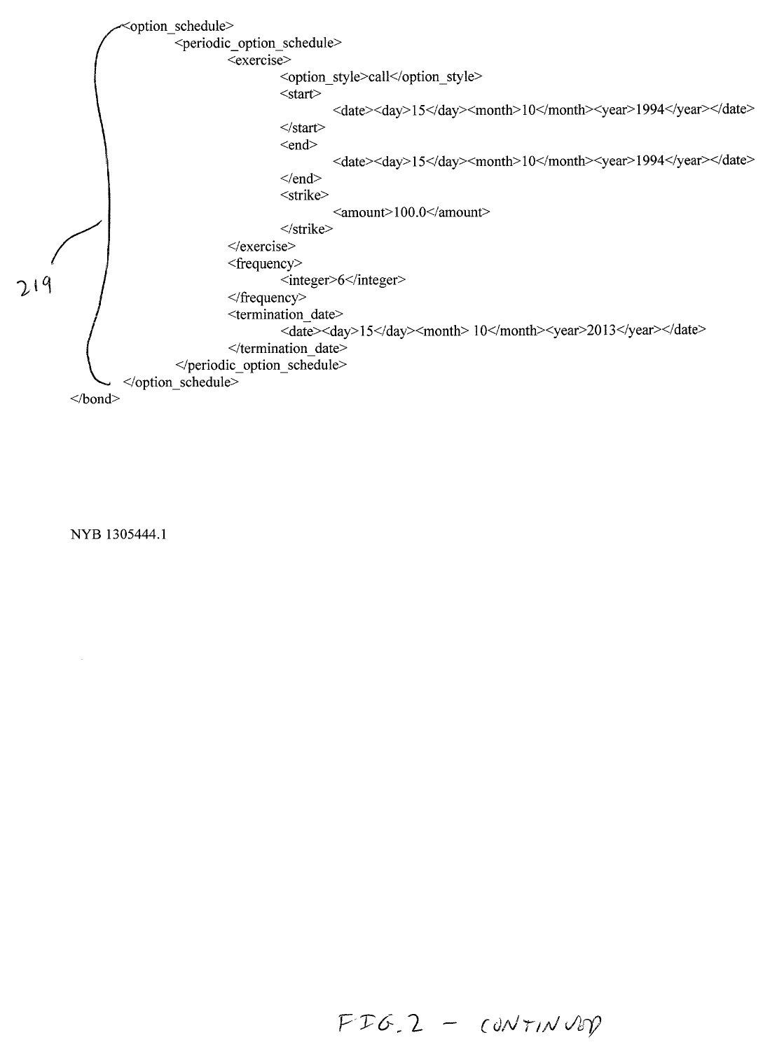

Referring now to FIG. 2, there is shown an XML document 201 for describing a particular corporate bond according to the document definition of DTD 101. The process of describing the bond using DTD 101 includes substituting the relevant values for the features that affect the yield of the particular bond and formatting the results into an XML document that conforms to DTD 101. For example, document 201 includes an identification section 203 that indicates that the country class for the particular bond is Brazil, the CUSIP number is tt3163066 and the ISIN number is XS0049993479. Document 201 also includes a calendar section 205 that defines a holiday center(s); a settlement section 207 that indicates settlement information; an accrual section 209 that defines an accrual periodic; a yield section 211 that defines a yield method and the day count type on which the yield calculation is based; a coupon section 213 that defines the coupon type (e.g., periodic), the first coupon date, the coupon maturity date and the coupon frequency; a capitalization section 215 in which a list of capitalization dates and amount are defined; an amortization section 217 in which a periodic amortization date and an amortization amount is defined; and an option schedule section 219 in which a periodic option schedule is defined as well as the option type, option start date, option strike price, frequency and option termination date.

Accordingly, XML document 201 may be used to accurately and uniformly define a bond by the attributes that affect the bond's yield. By conforming to the document definition contained in DTD 101, an entity may describe the particular bond and accurately communicate the bond description to other entities that adhere to the document definition of DTD 101.

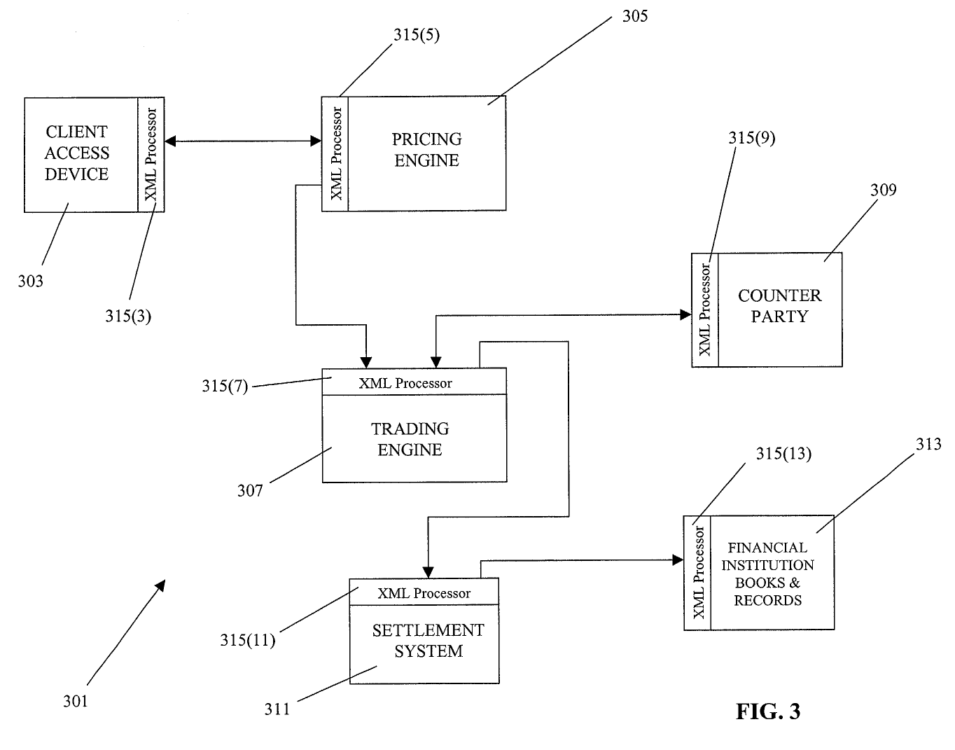

Referring now to FIG. 3, there is shown a block diagram of a system 301 in which bond information is communicated according to the method of the present invention. System 301 includes a client access device 303 (for example a personal computer executing a graphical user interface) that receives bond price quote from a pricing engine 305 that is operated by a financial institution and that receives real-time information and calculates a bond price. In the event the client desires to execute a transaction based on the price quote received, pricing engine 305 forwards a bond trade request to a trading engine 307. Trading engine 307 may communicate with a counterparty 309 in order to complete the trade request requested by the client. Once the trade is completed, trading engine 311 communicates the transaction details to a settlement system 311 that in turn causes the transaction information to be posted in the financial institution's books and records 313.

Each device in system 301 includes an XML processor 315 for ensuring that communications between the devices are according to the document definition of DTD 101. For example, upon determining a price quote in response to a price request from a client, pricing engine 305 passes the bond price quote details to XML processor 315(5) that then formats the bond information associated with the price quote into an XML document that conforms to the document definition of DTD 1101. XML processor 315(3) associated with client access device 303 then receives the XML document and presents the bond information to client access device 303 in any format suitable for presentation to the client. Similarly, communications between pricing engine 305 and trading engine 315 is managed by XML processors 315(5) and 315(7), respectively, so that communications conform to the document definition of DTD 101. XML processors 315(11), 315(9) and 315(13) provide a similar function in managing the communication of bond information on behalf of settlement system 311, counterparty 309 and books and records 313, respectively. Thus, because each device in system 301 communicates with any other device according to the uniform document definition of DTD 101, the communicating of bond information between devices is accurate and efficient.

In an exemplary embodiment, each device in system 301 communicates natively in XML according to the document definition of DTD 101. For example, upon determining a price quote in response to a price request, pricing engine 305 formats the bond information associated with the price quote into an XML document according to the document definition of DTD 101. While system 301 includes certain devices and entities that describe bond attributes and communicate such bond information using an XML syntax according to the document definition of DTD 101 of the present invention, any other device or entity that desires to describe a bond and communicate such bond information may do so using XML syntax according to the document definition of DTD 101.

Although the description above included the use of XML syntax for creating documents to describe the attributes of a bond, it will be obvious based on the above to use any other document formats in a similar way to uniformly and accurately define the characteristics and features of a bond. Also, it will be obvious based on the description above to apply the method of the present invention to financial instruments other than bonds and to other information as well.

Accordingly, the present invention provides a method for describing debt instruments in an accurate and uniform manner. Under the present invention, a document type definition is provided that includes bond attributes and features that affect the yield of bonds and that are therefore necessary for describing the bond. Based on the document type definition, an XML document is formed for a particular bond by inserting the values for the attributes that affect the yield of the bond in the XML document. By describing bond information uniformly using the document type definition of the present invention, bond information can be accurately and efficiently communicated between different entities.

A number of embodiments of the present invention have been described. Nevertheless, it will be understood that various modifications may be made without departing from the spirit and scope of the invention. Based on the above description, it will be obvious to one of ordinary skill to implement the system and methods of the present invention in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Furthermore, alternate embodiments of the invention that implement the system in hardware, firmware or a combination of both hardware and software, as well as distributing modules and/or data in a different fashion will be apparent to those skilled in the art and are also within the scope of the invention. In addition, it will be obvious to one of ordinary skill to use a conventional database management system such as, by way of non-limiting example, Sybase, Oracle and DB2, as a platform for implementing the present invention. Also, network access devices can comprise a personal computer executing an operating system such as Microsoft Windows™, UniX™, or Apple Mac OS™, as well as software applications, such as a JAVA program or a web browser. Network access devices 203-205 can also be a terminal device, a palm-type computer, mobile WEB access device or other device that can adhere to a point-to-point or network communication protocol such as the Internet protocol. Computers and network access devices can include a processor, RAM and/or ROM memory, a display capability, an input device and hard disk or other relatively permanent storage. Accordingly, other embodiments are within the scope of the following claims.

It will thus be seen that the objects set forth above, among those made apparent from the preceding description, are efficiently attained and, since certain changes may be made in carrying out the above process, in a described product, and in the construction set forth without departing from the spirit and scope of the invention, it is intended that all matter contained in the above description shown in the accompanying drawing shall be interpreted as illustrative and not in a limiting sense.

It is also to be understood that the following claims are intended to cover all of the generic and specific features of the invention herein described, and all statements of the scope of the invention, which, as a matter of language, might be said to fall therebetween.

[image]

[image]

[image]

[image]

[image]

[image]

[image]

[image]

[image]

[image]

[image]

[image]

1. A method for communicating a description of a bond between a first entity and a second entity, comprising the steps of:
selecting at least some attributes that are associated with the bond from a plurality of bond attributes;
choosing a value for each of said at least some attributes;
creating said description of said bond by formatting said values for said at least some attributes according to a document type definition; and
communicating said description of said bond between said first entity and said second entity.

2. The method of claim 1, wherein said bond attributes include the maturity and redemption.

3. The method of claim 2, wherein said bond attributes includes at least one attribute selected from the group including a coupon type, a settlement date, an ex-dividend date, an accrual type, an amortization rate, a capitalization date, a tax status and a recovery right.

4. The method of claim 1, wherein said bond has a yield and at least some of said at least some attributes relate to said yield of said bond.

5. The method of claim 1, wherein at least some of said at least some of said attributes identify said bond.

6. The method of claim 1, wherein said document type definition conforms to an Extensible Markup Language syntax.

7. The method of claim 1, wherein said bond is a corporate bond.

8. The method of claim 1, wherein said bond is a government bond.

9. The method of claim 1, wherein said bond is an emerging market bond.

10. A method for forming a description of a bond, comprising the steps of:
selecting at least some attributes that are associated with the bond from a plurality of bond attributes;
choosing a value for each of said at least some attributes; and
creating said description of said bond by formatting said values for said at least some attributes according to a document type definition.

11. The method of claim 10, further comprising a first entity and a second entity and wherein the method further comprises the step of:
communicating said description of said bond between said first entity and said second entity.

12. The method of claim 10, wherein said bond attributes include the maturity, redemption, credit quality, interest rate and price.

13. The method of claim 12, wherein said bond attributes includes at least one attribute selected from the group including a coupon type, a settlement date, an ex-dividend date, an accrual type, an amortization rate, a capitalization date, a tax status and a recovery right.

14. The method of claim 10, wherein said bond has a yield and at least some of said at least some attributes relate to said yield of said bond.

15. The method of claim 10, wherein at least some of said at least some of said attributes identify said bond.

16. The method of claim 10, wherein said document type definition conforms to an Extensible Markup Language syntax.

17. The method of claim 10, wherein said bond is a corporate bond.

18. The method of claim 10, wherein said bond is a government bond.

19. The method of claim 10, wherein said bond is an emerging market bond.

20. A system for communicating a description of a bond, comprising:
a first entity, said first entity selecting at least some attributes that are associated with the bond from a plurality of bond attributes, said first entity choosing a value for each of said at least some attributes and said first entity creating said description of said bond by formatting said values for said at least some attributes according to a document type definition; and
a second entity in communications with said first entity;
wherein when said first entity communicates said description of said bond to said second entity, said second entity interprets said description according to said document type definition.

21. The system of claim 20, wherein said bond attributes include the maturity and redemption.

22. The system of claim 21, wherein said bond attributes includes at least one attribute selected from the group including a coupon type, a settlement date, an ex-dividend date, an accrual type, an amortization rate, a capitalization date, a tax status and a recovery right.

23. The system of claim 20, wherein said bond has a yield and at least some of said at least some attributes relate to said yield of said bond.

24. The system of claim 20, wherein at least some of said at least some of said attributes identify said bond.

25. The system of claim 20, wherein said document type definition conforms to an Extensible Markup Language syntax.

26. The system of claim 20, wherein said bond is a corporate bond.

27. The system of claim 20, wherein said bond is a government bond.

28. The system of claim 20, wherein said bond is an emerging market bond.

29. The system of claim 20, wherein said first entity includes an XML processor for formatting said values for said at least some attributes according to a document type definition.

30. The system of claim 20, wherein said second entity includes an XML processor for interpreting said description according to said document type definition.
